(19) United States
(12) Patent Application Publication
(10) Pub. No.: US 2008/0034076 A1
(43) Pub. Date: Feb. 7, 2008

(54) Load distribution method in NAS migration, and, computer system and NAS server using the method

(76) Inventors: Yuuichi Ishikawa, Yokohama (JP); Nobuyuki Saika, Yokosuka (JP); Takumi Ikemoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/541,533

(22) Filed: Oct. 3, 2006

(30) Foreign Application Priority Data
Aug. 3, 2006 (JP) 2006-211830

(51) Int. Cl. G06F 15/173

(52) U.S. Cl. 709/223; 709/226

(57) ABSTRACT

Provided is a method for controlling a computer system including a first server computer, a second server computer, at least one data storing device, and a client computer. The first server computer manages a first file system. The second server computer manages a second file system. The second file system includes data copied from the first file system. Data written in the second file system after data is copied from the first file system is stored in a shared volume. In the method, when a load on the second server computer is higher than a load on the first server computer, copy of the data stored in the shared volume to the first file system is started and a read request from a client computer is issued to the first server computer. Accordingly, it is possible to execute high-speed distribution of an access load of a storage system.

### CLAIM OF PRIORITY

The present application claims priority from Japanese application JP2006-211830 filed on Aug. 3, 2006, the content of which is hereby incorporated by reference into this application.

### BACKGROUND

This invention relates to an improvement in performance of a storage system, and more particularly, to a load distribution method by migration in an aggregate NAS.

In network storages used by large scale customers, for example, a network attached storage (NAS), there is a demand for an improvement in performance and expansion of a disk capacity along with an increase in number of users. However, there are limits in performance and a disk capacity that can be realized by one NAS. Therefore, it is necessary to make it possible to use a plurality of NASs from one client in order to meet the demand. Thus, an aggregate NAS has been developed. The aggregate NAS is a function of adding a NAS without stopping operations for a long time for resetting of a NAS client or data transition.

Migration by the aggregate NAS is executed to make it possible to use a file system, which is used in a certain NAS chassis, in a NAS server added in the chassis or a NAS chassis added. The migration is realized by switching of a path in an identical chassis, switching of a path between chassis, data copy in an identical chassis, or data copy to another chassis (so-called remote copy). By registering, in a global name space (GNS, that is, position information of a file), information indicating in which NAS server a file system can be used, a user can use the file system without changing a setting of a NAS server. As such a technique for showing a plurality of computers (NAS servers) as if the computers are one computer (NAS server), JP 2005-148962 A is disclosed.

### SUMMARY

A client is capable of executing file system access to a plurality of chassis using migration of a NAS. However, there are the following problems concerning time required for execution of the migration and load distribution after the migration is executed.

First, migration by data copy requires time for execution of the data copy. Thus, the migration by data copy requires long time compared with migration by switching of a path.

Second, when migration by switching of a path between chassis is executed, a chassis at a migration destination is externally connected to a chassis at a migration source. Access from the client to a file system migrated reaches the chassis at the migration source through the chassis at the migration destination. As a result, response to the access from the client deteriorates. In order to prevent the response deterioration, it is necessary to copy data to the chassis at the migration destination.

Third, for example, when a load on the NAS suddenly fluctuates because of a sudden increase in writing, it is assumed that the migration by data copy cannot catch up with the fluctuation in the load. Therefore, it is necessary to select a method of migration according to a state of fluctuation in a load.

According to a representative aspect of this invention, there is provided a method for controlling a computer system including a first server computer, a second server computer, at least one data storing device, and a client computer, the first server computer, the second server computer, and the client computer being coupled via a network, the first server computer and the second server computer being coupled to the at least one data storing device, the first server computer managing a first file system in any one of the data storing devices, the second server computer managing a second file system in any one of the data storing devices, the second file system including data copied from the first file system, and data written in the second file system after data is copied from the first file system being stored in a shared volume in any one of the data storing devices, the method including: judging whether a load on the second server computer is higher than a load on the first server computer; and when the load on the second server computer is higher than the load on the first server computer, starting copy of the data stored in the shared volume to the first file system and issuing an access request from the client computer to the first server computer.

According to an embodiment of this invention, since time required for migration is reduced, it is possible to reduce a difference of execution time of migration in a chassis and migration between chassis. It is also possible to reduce time for file access by distributing a load to a plurality of chassis while preventing inconsistency from occurring in a file system. Moreover, it is possible to switch a NAS at high speed by executing migration corresponding to a state of a load. As a result, even when fluctuation in a load is intense, it is possible to realize high-speed load distribution following the fluctuation.

### BRIEF DESCRIPTION OF THE DRAWINGS

FIG. 1 is a block diagram showing a structure of a computer system according to an embodiment of this invention.

FIG. 2 is a block diagram showing a structure of a NAS according to the embodiment of this invention.

FIG. 3 is a diagram for explaining processing executed when a storage system is added in the computer system according to the embodiment of this invention.

FIG. 4 is a diagram for explaining processing executed during an operation of the storage system added in the computer system according to the embodiment of this invention.

FIG. 5 is a diagram for explaining migration by data copy according to the embodiment of this invention.

FIG. 6 is a diagram for explaining migration with a use of a shared volume according to the embodiment of this invention.

FIG. 7 is a flowchart showing entire load distribution processing executed in the computer system according to the embodiment of this invention.

FIG. 8 is a flowchart showing processing executed by a write request processing module of a NAS client according to the embodiment of this invention.

FIG. 9 is a flowchart showing processing executed by a read request processing module of the NAS client according to the embodiment of this invention.

FIG. 10 is a flowchart showing writing processing executed by a file system processing module according to the embodiment of this invention.

FIG. 11 is a flowchart showing reading processing executed by the file system processing module according to the embodiment of this invention.

FIG. 12 is a flowchart showing load monitoring processing executed by a load distribution processing module according to the embodiment of this invention.

FIG. 13 is a flowchart showing takeover processing executed by the load distribution processing module according to the embodiment of this invention.

### DETAILED DESCRIPTION OF THE PREFERRED EMBODIMENTS

An embodiment of this invention will be hereinafter described with reference to the accompanying drawings.

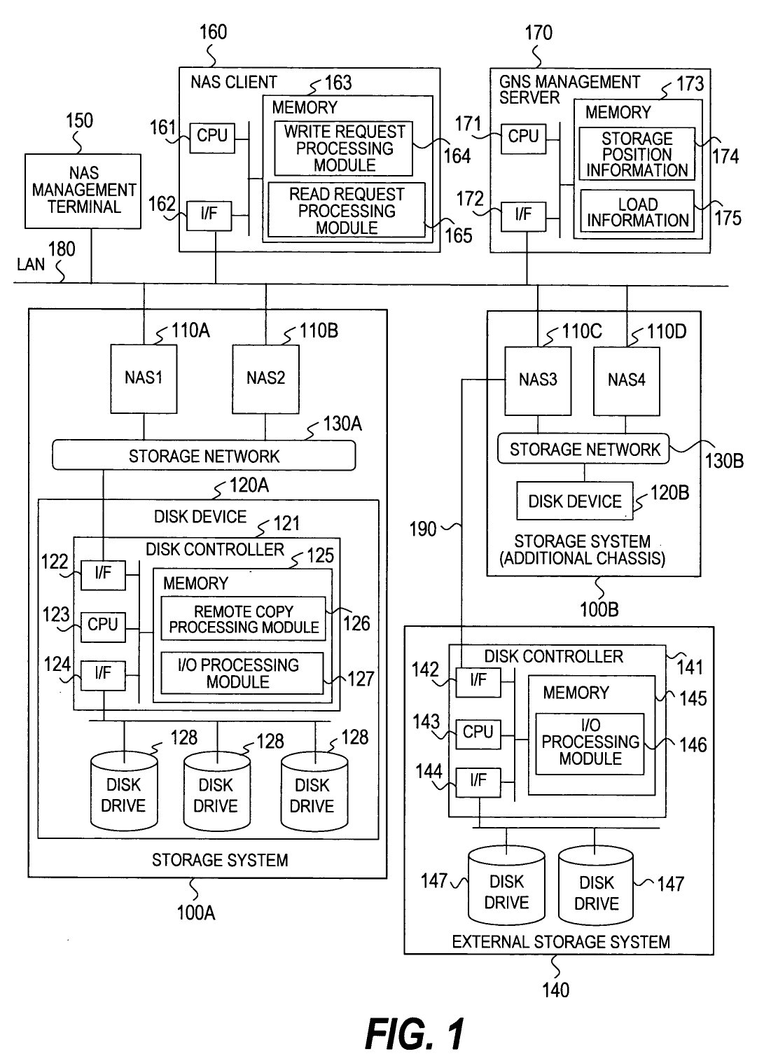

FIG. 1 is a block diagram showing a structure of a computer system according to the embodiment of this invention.

The computer system according to this embodiment includes a storage system 100A, a storage system 100B, an external storage system 140, a network attached storage (NAS) management terminal 150, a NAS client 160, and a global name space (GNS) management server 170.

The storage system 100A, the storage system 100B, the external storage system 140, the NAS management terminal 150, the NAS client 160, and the GNS management server 170 are connected by a local area network (LAN) 180. On the other hand, the storage system 100B and the external storage system 140 are connected by an external network 190.

The storage system 100A includes a NAS1 110A, a NAS2 110B, a disk device 120A, and a storage network 130A.

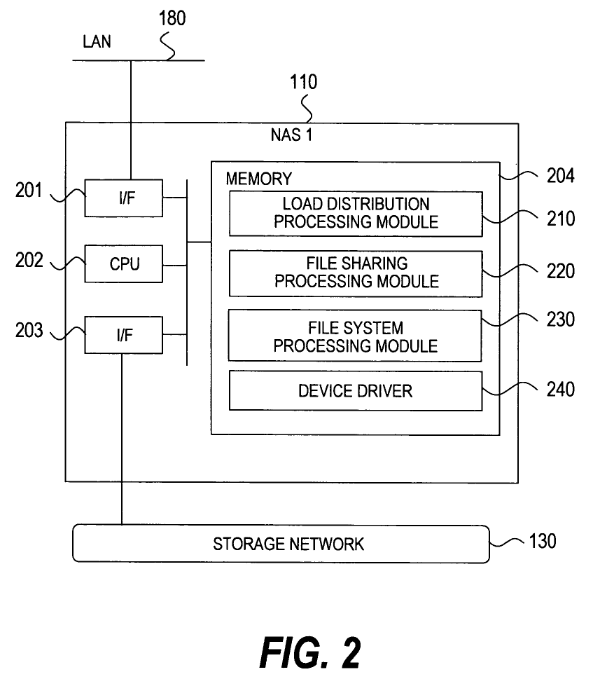

The NAS1 110A and the NAS2 110B are computers (so-called NAS servers or NAS nodes) for connecting the disk device 120A to the LAN 180. A structure of the NAS2 110B is the same as that of the NAS1 110A. The structure of the NAS1 110A and the like will be explained in detail later as shown in FIG. 2.

The disk device 120A is a device that stores data written by the NAS client 160. The disk device 120A according to this embodiment includes a disk controller 121 and a disk drive 128.

The disk drive 128 is a storage device that provides a storage area for data. The disk drive 128 may be, for example, a hard disk drive (HDD) or devices of other types (e.g., a semiconductor storage device such as a flash memory). The disk device 120A may include a plurality of disk drives 128. The plurality of disk drives 128 may constitute redundant arrays of inexpensive disks (RAID) structure. Data written by the NAS client 160 is finally stored in a storage area provided by the disk drive 128.

The disk controller 121 is a control device that controls the disk device 120A. The disk controller 121 according to this embodiment includes an interface (I/F) 122, a CPU 123, an I/F 124, and a memory 125 connected to one another.

The I/F 122 is an interface that connects the disk controller 121 to the storage network 130A. The disk controller 121 communicates with the NAS1 110A and the like, which are connected to the storage network 130A via the I/F 122.

The CPU 123 is a processor that executes a program stored in the memory 125.

The I/F 124 is an interface that connects the disk controller 121 to the disk drive 128. The disk controller 121 executes writing of data in and reading of data from the disk drive 128 via the I/F 124.

The memory 125 is, for example, a semiconductor memory. The memory 125 stores the program executed by the CPU 123 and data referred to by the CPU 123. The memory 125 according to this embodiment stores at least a remote copy processing module 126 and an I/O processing module 127.

The remote copy processing module 126 is a program module that executes data copy between the storage system 100A and other storage systems (e.g., the storage system 100B).

The I/O processing module 127 is a program module that controls writing of data in and reading of data from the disk drive 128.

The disk controller 121 may further include a cache memory (not shown) that temporarily stores data.

The storage network 130A is a network that mediates communication among the NAS1 110A, the NAS2 110B, and the disk device 120A. The storage network 130A may be a network of an arbitrary type. For example, the storage network 130A may be a PCI bus or a fibre channel (FC) network.

The storage system 100B includes a NAS3 110C, a NAS4 110D, a disk device 120B, and a storage network 130B. These devices are the same as the NAS1 110A, the NAS2 110B, the disk device 120A, and the storage network 130A included in the storage system 100A, respectively. Thus, explanations of the devices are omitted.

A structure of the disk device 120B is the same as that of the disk device 120A. Thus, illustration and explanation of the disk device 120B are omitted.

In the following explanation, when it is unnecessary to specifically distinguish the NAS1 100A to the NAS4 110D from one another, these NASs are generally referred to as NASs 110. Similarly, when it is unnecessary to specifically distinguish the storage networks 130A and 130B from each other, these networks are generally referred to as storage networks 130. When it is unnecessary to specifically distinguish the storage systems 100A and 100B, these storage systems are generally referred to as storage systems 100.

An example in FIG. 1 shows a structure of a computer system in which, as explained in detail later, only the storage system 100A is operated in the beginning and the storage system 100B is added later. However, the computer system according to this embodiment may include an arbitrary number of storage systems 100.

Each of the storage systems 100 shown in FIG. 1 includes two NASs 110 and one disk device 120. However, each of the storage systems 100 according to this embodiment may include an arbitrary number of NASs 110 and an arbitrary number of disk devices 120.

The storage networks 130A and 130B according to this embodiment may be connected to each other.

The external storage system 140 is connected to the storage system 100 via the external network 190 in order to provide a shared volume to be explained later. The external storage system 140 includes a disk controller 141 and a disk drive 147.

Since the disk drive 147 is similar to the disk drive 128, explanation of the disk drive 147 is omitted.

The disk controller 141 is a control device that controls the external storage system 140. The disk controller 141 according to this embodiment includes an I/F 142, a CPU 143, an I/F 144, and a memory 145 connected to one another. Since these devices are the same as the I/F 122, the CPU 123, the I/F 124, and the memory 125, respectively, detailed explanations of the devices are omitted.

However, the I/F 142 is connected to the external network 190 and communicates with the NASs 110 of the storage system 110B. An I/O processing module 146 is stored in the memory 145.

The external network 190 is a network that mediates communication between the NAS 110 and the external storage system 140. The external network 190 may be a network of an arbitrary type. For example, the external network 190 may be an FC network.

In the example in FIG. 1, the external network 190 is connected to the NAS3 110C. However, the external network 190 may be connected to any one of the NASs 110. Alternatively, the external network 190 may be physically connected to all the NASs 110. In that case, it is possible to make communication between the external storage system 140 and an arbitrary NAS 110 possible by logically switching connection between the NASs 110 and the external storage system 140 (e.g., switching a setting of an access path).

The NAS management terminal 150 is a computer that manages the computer system shown in FIG. 1. The NAS management terminal 150 according to this embodiment includes a CPU (not shown), a memory (not shown), and an I/F (not shown) connected to the LAN 180. The NAS management terminal 150 manages the computer system using the CPU that executes a management program (not shown) stored in the memory.

The NAS client 160 is a computer that executes various applications using the storage systems 100. The NAS client 160 according to this embodiment includes a CPU 161, an I/F 162, and a memory 163.

The CPU 161 is a processor that executes a program stored in the memory 163.

The I/F 162 is an interface that connects the NAS client 160 to the LAN 180. The NAS client 160 communicates with, via the I/F 162, apparatuses connected to the LAN 180.

The memory 163 is, for example, a semiconductor memory. The memory 163 stores a program executed by the CPU 161 and data referred to by the CPU 161. The memory 163 according to this embodiment stores at least a write request processing module 164 and a read request processing module 165.

The write request processing module 164 and the read request processing module 165 are provided as a part of an operating system (OS) (not shown). The OS of the NAS client 160 may be an arbitrary one (e.g., Windows or Solaris).

The memory 163 further stores various application programs (not shown) executed on the OS. Write requests and read requests issued by the application programs are processed by the write request processing module 164 and the read request processing module 165. Processing executed by these processing modules will be explained in detail later.

One client 160 is shown in FIG. 1. However, the computer system according to this embodiment may include an arbitrary number of NAS clients 160.

The GNS management server 170 is a computer that manages a global name space (GNS). In this embodiment, file systems managed by the plurality of NASs 110 are provided to the NAS client 160 by a single name space. Such the single name space is the GNS.

The GNS management server 170 according to this embodiment includes a CPU 171, an I/F 172, and a memory 173.

The CPU 171 is a processor that executes a program stored in the memory 173.

The I/F 172 is an interface that connects the GNS management server 170 to the LAN 180. The GNS management server 170 communicates with, via the I/F 172, apparatuses connected to the LAN 180.

The memory 173 is, for example, a semiconductor memory. The memory 173 stores a program executed by the CPU 171 and data referred to by the CPU 171. The memory 173 according to this embodiment stores at least storage position information 174 and load information 175. These kinds of information will be explained in detail later.

FIG. 2 is a block diagram showing a structure of the NAS 110 according to the embodiment of this invention.

The NAS 110 includes an I/F 201, a CPU 202, an I/F 203, and a memory 204 connected to one another.

The I/F 201 is an interface that connects the NAS 110 to the LAN 180. The NAS 110 communicates with, via the I/F 201, apparatuses connected to the LAN 180.

The CPU 202 is a processor that executes a program stored in the memory 204.

The I/F 203 is an interface that connects the NAS 110 to the storage network 130. The NAS 110 communicates with the disk device 120 via the I/F 203.

The memory 204 is, for example, a semiconductor memory. The memory 204 stores a program executed by the CPU 202, data referred to by the CPU 202, and the like. The memory 204 according to this embodiment stores, as program modules executed by the CPU 202, at least a load distribution processing module 210, a file sharing processing module 220, a file system processing module 230, and a device driver 240. The file system processing module 230 and the device driver 240 are provided as a part of an OS (not shown) of the NAS 110.

The load distribution processing module 210 is a program module executed by the CPU 202 to distribute a load on the NAS 110. Processing executed by the load distribution processing module 210 will be explained in detail later.

The file sharing processing module 220 provides a file sharing function between the NAS clients 160 by providing the NAS client 160, which is connected to the LAN 180, with a file sharing protocol. The file sharing protocol may be, for example, a network file system (NFS) or a common internet file system (CIFS). When the file sharing processing module 220 receives a read request or a write request in file units from the NAS client 160, the file sharing processing module 220 executes I/O (read or writing) processing in file units corresponding to the request on a file system.

The file system processing module 230 provides an upper layer with logical views (i.e., directory, file, etc.) which are hierarchically structured. In addition, the file system processing module 230 converts these views into a physical data structure (i.e., block data or block address) and executes I/O processing for a lower layer. Processing executed by the file system processing module 230 will be explained in detail later.

The device driver 240 executes block I/O requested by the file system processing module 230.

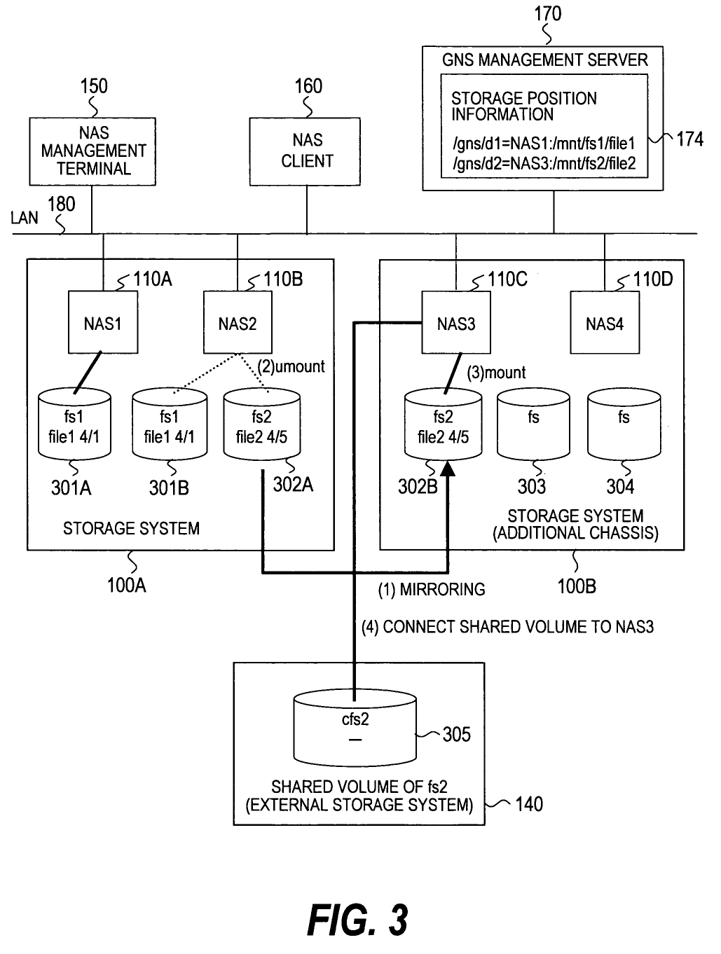

Processing executed in the computer system explained with reference to FIGS. 1 and 2 will be hereinafter schematically explained with reference to the drawings. In FIG. 3 and the subsequent figures, illustration of hardware unnecessary for explanation is omitted.

As explained above, in the computer system according to this embodiment shown in FIG. 1, only the storage system 100A is provided in the beginning and the storage system 100B is added later. The addition of the storage system 100B may be executed when a load on the NASs 110 in the storage system 100A exceeds a predetermined value or may be executed when a free capacity of the disk drive 128 in the storage system 100A falls below a predetermined value.

FIG. 3 is a diagram for explaining processing executed when the storage system 100B is added in the computer system according to the embodiment of this invention.

In FIG. 3, a case where the storage system 100B is added when a load on the NAS2 110B increases is shown as an example.

File systems are generated in storage areas of the respective storage systems 100. In FIG. 3, an fs1 301A, an fs1 301B, an fs2 302A, an fs2 302B, an fs303, and an fs304 are all file systems. Each of the file systems are managed by any one of the NASs 110.

In the example of FIG. 3, contents of the fs1 301A and the fs1 301B are identical. Specifically, both the fs1 301A and the fs1 301B store an identical file “file1”. “4/1” shown near the “file1” is a time stamp indicating a last update date of the file1. “4/1” indicates that the last update date is April 1. On the other hand, a time stamp of a file2 is “4/5”. This indicates that a last update date of the file2 is April 5.

In the following explanation, files having both an identical file name (“file1”, etc.) and an identical last update date are identical files (i.e., files consisting of identical pieces of data). Two files having an identical file name but different last update dates indicate that the files were identical files before, but since one of the files was updated after that, the files presently include different pieces of data.

In FIG. 3, for simplification of the explanation, a case where one file system includes only one file is shown as an example. However, actually, each of the file systems includes an arbitrary number of files. When contents of two file systems are identical, this means that all files included in the file systems are identical.

The storage system 100A includes an fs1 301A, an fs1 301B, and an fs2 302A. Among these file systems, the fs1 301B and the fs2 302A are managed by the NAS2 110B. In the beginning, the fs1 301B and the fs2 302A are mounted on the NAS2 110B.

After that, when the storage system 100B is added, content (i.e., data) of the fs2 302A is copied to the storage system 100B. As a result, an fs2 302B having content identical with that of the fs2 302A is generated in the storage system 100B (1). Such the data copy is also called mirroring.

When the storage networks 130A and 130B are connected to each other, data copy from the storage system 100A to the storage system 100B may be executed through the storage networks 130A and 130B and not through the NASs 110. When the storage networks 130A and 130B are not connected to each other, data copy from the storage system 100A to the storage system 100B may be executed through the NASs 110 and the LAN 180.

Subsequently, the fs2 302A is unmounted according to an umount command (2).

Next, the fs2 302B is mounted on the NAS3 110C according to a mount command.

A cfs2 305, which is a shared volume of the fs2 302A and the fs2 302B, is connected to and mounted on the NAS3 110C (4). The shared volume cfs2 305 is a logical storage area set in the external storage system 140.

At this point, “/gns/d1=NAS1:/mnt/fs1/file1” and “/gns/d2=NAS3:/mnt/fs2/file2” are stored in the GNS management server 170 as the storage position information 174. These indicate that “the file1 is included in the fs1 301A managed by the NAS1 100A” and that “the file2 is included in the fs2 302B managed by the NAS3 110C”, respectively. The NAS client 160 can find, with reference to the storage position information 174, in which file system managed by which NAS 110 a file to be accessed is included.

As shown in FIG. 3, one file system (in the case of FIG. 3, fs2) under the management of one NAS 110 is transitioned to be under management of another NAS 110. This transition is called migration.

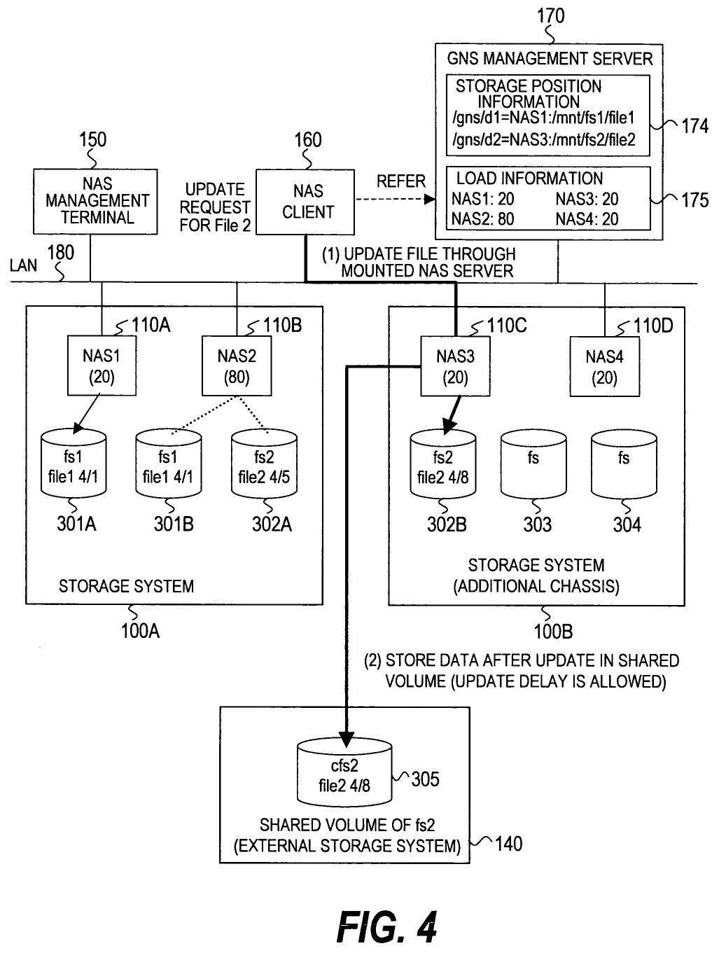

FIG. 4 is a diagram for explaining processing executed during an operation of the storage system 100B added in the computer system according to the embodiment of this invention.

Specifically, in FIG. 4, a processing in which the NAS client 160 issues a write (update) request for the file2 after execution of Step (4) in FIG. 3 is shown as an example.

Before issuing a write request to the NAS 110, the NAS client 160 accesses the GNS management server 170 and acquires information indicating a storage position of a file to be written (1). Specifically, the NAS client 160 acquires, with reference to the storage position information 174, information indicating that the file2 to be written is included in the fs2 302B managed by the NAS3 110C.

Subsequently, the NAS client 160 issues a write request for the file2 to the NAS3 110C in accordance with the information acquired. As a result, the file2 included in the fs2 302B is updated. When this update is executed on April 8, a time stamp of the file2 included in the fs2 302B is “4/8” (April 8).

Moreover, the NAS3 110C writes the updated file2 in the cfs2 305 (2). A time stamp of the file2 written in the cfs2 305 is also “4/8”. When a load on the NAS3 110C is large, the writing in Step (2) may be executed after the load on the NAS3 110C is reduced. In that case, information indicating data constituting the file2 to be written and a position in which the file2 is written is held on the NAS3 110C. The writing in Step (2) is executed on the basis of the information.

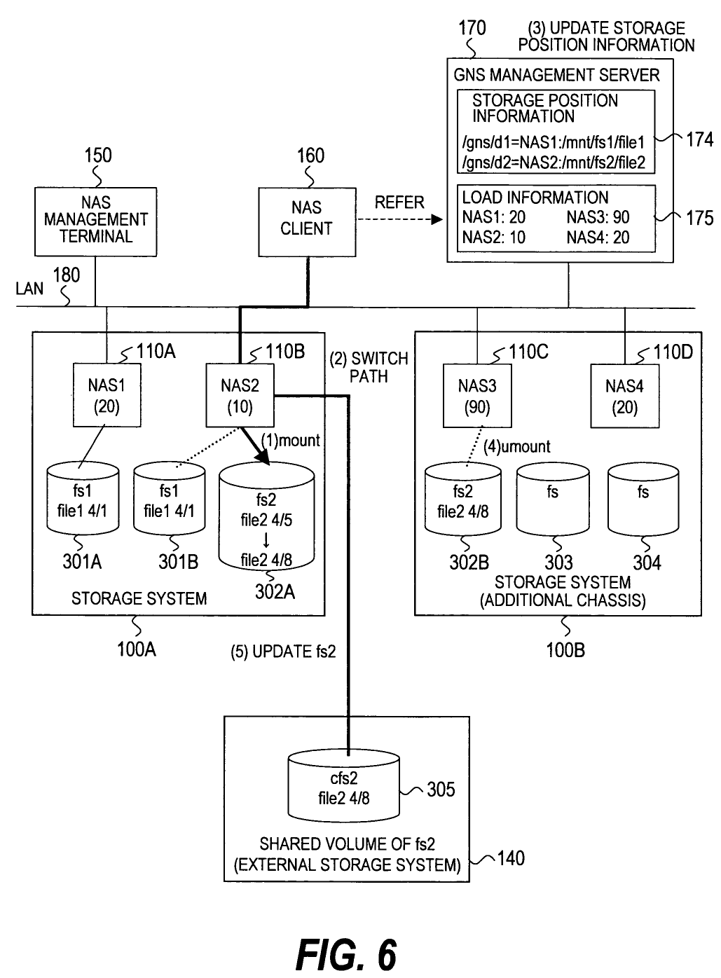

Alternatively, only updated data (i.e., difference data) among the data constituting the file2 may be written in the cfs2 305 instead of the entire file2 which has been updated. As a result, since an amount of data written in the cfs2 305 decreases, time required for processing for writing in the cfs2 305 is reduced. Moreover, time required for copy of data from the cfs2 305 to the fs2 302A, which will be explained later with reference to FIG. 6, is also reduced.

In both cases, data written in the fs2 302B after data is copied to the fs2 302B from the fs2 302A is written in the shared volume cfs2 305.

As a result of execution of Step (2), the identical file2 updated is stored in the fs2 302B and the cfs2 305. On the other hand, since the file2 included in the fs2 302A is not updated, the time stamp of the file2 continues to be “4/5” (i.e., April 5). At this point, a version of the file 2 included in the fs2 302A is older than a version of the file2 included in the fs2 302B.

When the NAS client 160 issues a read (i.e., reference) request for the file2, Step (1) is executed as described above. After that, the NAS client 160 issues the read request for the file2 to the NAS3 110C. However, since the file2 is not updated in this case, the time stamp of the file2 continues to be “4/5” (i.e., April 5). Further, since the file2 is not updated, Step (2) is not executed.

Each of the NASs 110 periodically notifies the GNS management server 170 of load information of the NAS 110. The load information is information used as an indicator of a level of a load on a NAS.

The load information may be, for example, operation statistic data of a system, SAR data of a NAS OS, a usage rate of the CPU 202, a usage rate of the memory 204, disk I/O frequency, or a size of a file to be inputted or outputted, which is acquired by using a Cruise Control Function. Alternatively, the load information may be a value calculated by weighting each of the plurality of values.

The GNS management server 170 stores the load information notified from each of the NASs 110 as load information 175 and centrally manages the load information.

In the example of FIG. 4, “NAS1:20, NAS2:80, NAS3:20, NAS4:20” is stored as the load information 175 of the GNS management server 170. This indicates that respective pieces of load information notified from the NAS 1 110A, the NAS2 110B, the NAS3 110C, and the NAS4 110D are 20, 80, 20, and 20, respectively (see numbers in parentheses in the respective NASs 110).

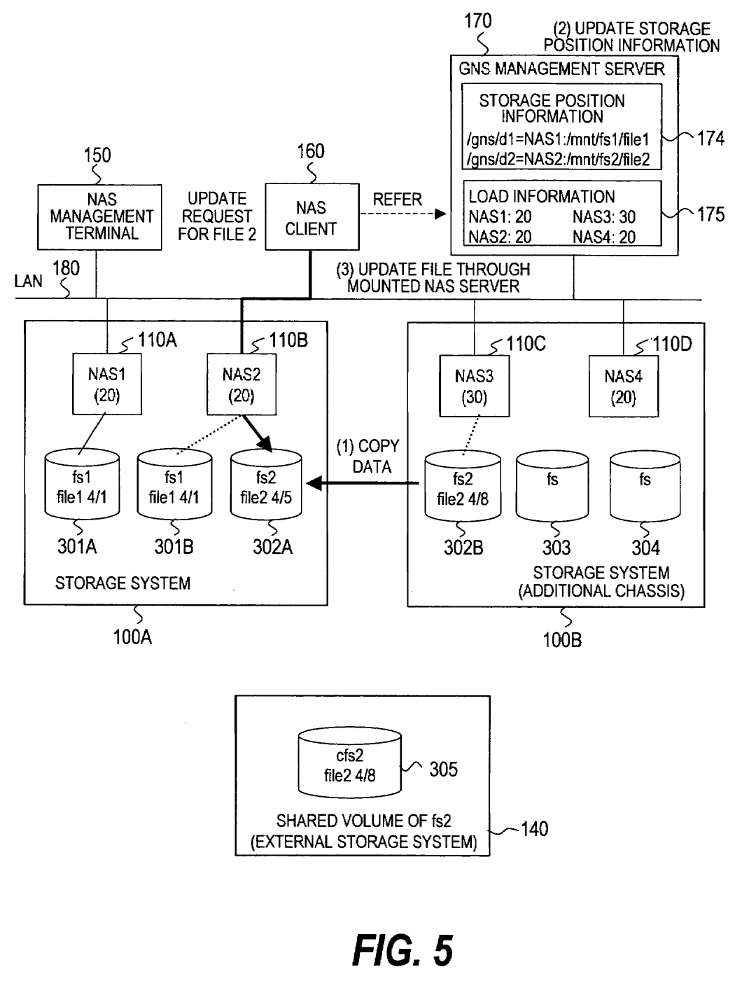

Processing executed when loads on the NASs 110 are reversed will be explained with reference to FIGS. 5 and 6.

The migration of the file systems explained with reference to FIG. 3 is executed to balance loads on the respective NASs 110 by distributing a part of a load concentrated on the NAS2 110B (i.e., load due to access to the fs2 302A) to the NAS3 110C. Since the NAS3 110C is included in the storage system 100B added anew, at a point when the migration is executed, a load on the NAS3 110C is “0”. In other words, at this point, the load on the NAS3 110C is lower than a load on the NAS2 110B.

However, after the migration is executed, the NAS3 110C may manage not only the fs2 302B but also the other file systems (e.g., the fs 303 or the fs 304). In this case, depending on frequency of access to the file systems, a load on the NAS3 110C may be higher than a load on the NAS2 110B. Such the reversal of a magnitude relation of loads on the two NASs 110 is referred to as “reversal of loads” in the following explanation.

When loads on a migration source (NAS2 110B in the example of FIG. 3) and a migration destination (NAS3 110C in the example of FIG. 3) are reversed as described above, it may be necessary to bring back the fs2 to be under the management of the NAS2 110B in order to balance the loads. Therefore, migration in an opposite direction (i.e., from the NAS3 110C to the NAS2 110B) is executed.

As shown in FIG. 4, the fs2 302A is included in the storage system 100A and the fs2 302B is included in the storage system 100B. If contents of the fs2 302A and the fs2 302B are identical, the fs2 302B is unmounted and the fs2 302A is mounted on the NAS2 110B again, whereby the fs2 is migrated to the NAS2 110B. After that, the client 160 can access the fs2 via the NAS2 110B. As a result, the loads on the respective NASs 110 are balanced.

However, in the example of FIG. 4, as a result of the update of the fs2 302B, contents of the fs2 302A and the fs2 302B are not identical. In this case, processing for making both the contents identical is required. As a method for such the processing, as described later, there is a method of executing data copy as shown in FIG. 5 and a method of using a shared volume as shown in FIG. 6.

The contents of the fs2 302A and the fs2 302B are made identical by the execution of the data copy. Thus, thereafter, it is possible to execute migration. However, in this case, it is impossible to execute the migration until the data copy ends. Therefore, this method is not appropriate when it is necessary to execute migration frequently.

On the other hand, when the method of using a shared volume is adopted, if the shared volume is connected to the NAS2 110B at a migration destination, it is possible to execute migration before copying data in the shared volume to the fs2 302A. Therefore, this method is appropriate when it is necessary to execute migration frequently.

It is necessary to execute migration frequently when the reversal of loads on a migration destination and a migration source described above frequently occurs. It is possible to predict whether the reversal of loads frequently occurs on the basis of, for example, whether the loads suddenly fluctuate. Specifically, when loads suddenly fluctuate, it is predicted that the reversal of loads frequently occurs due to continuation of such the sudden fluctuation in the loads.

On condition that loads on the respective NASs 110 are monitored and processing for balancing the loads is executed, it is possible to judge whether the loads have suddenly fluctuate on the basis of, for example, a difference of loads on the respective NASs 110. Specifically, when a difference of loads on the two NASs 110 is larger than a predetermined threshold, it is judged that the loads have suddenly change. In this case, it is predicted that the reversal of loads frequently occurs. Therefore, in this case, it is desirable to execute the migration using a shared volume. On the other hand, when a difference of loads on the two NASs 110 is equal to or smaller than the predetermined threshold, it is predicted that the reversal of loads does not frequently occur. Thus, it is desirable to execute the migration by data copy.

In an example in the following explanation, it is judged whether the reversal of loads frequently occurs on the basis of a difference of loads on the two NASs 110. However, it is also possible to realize this embodiment even when other methods are employed to judge whether the reversal of loads frequently occurs.

The threshold used for the judgment on a difference of loads on the two NASs 110 is set by a system administrator. The judgment on a difference of loads may be executed on the basis of values of loads at a certain point in time or may be executed on the basis of an average value of loads within a predetermined time in order to take into account a duration of loads.

FIG. 5 is a diagram for explaining the migration by data copy according to the embodiment of this invention.

In FIG. 5, a difference of loads on the NAS 2 110B and the NAS3 110C is equal to or lower than the predetermined threshold. Specifically, for example, loads on the NAS2 110B and the NAS3 110C are “20” and “30”, respectively. When a difference of loads “10” is equal to or lower than the predetermined threshold, the migration by data copy is executed.

In an example of FIG. 5, first, data included in the fs2 302B is copied to the fs2 302A (1). In this case, only difference data of the fs2 302B and the fs2 302A may be copied. As a result, contents of the fs2 302B and the fs2 302A are made identical.

After that, the fs2 302B is unmounted and the fs2 302A is mounted on the NAS2 110B. Moreover, the storage position information 174 of the GNS management server 170 is updated (2).

After that, when the NAS client 160 issues a write (update) request for the file2, the NAS client 160 refers to the storage position information 174. The NAS client 160 then issues a write request for the file2 to the NAS2 110B, which manages the fs2 302A, in accordance with the storage position information 174 (3). The same holds true when the NAS client 160 issues a read request.

As described above, when the migration by data copy is executed, the shared volume cfs2 305 is not used.

FIG. 6 is a diagram for explaining the migration using a shared volume according to the embodiment of this invention.

In FIG. 6, a difference of loads on the NAS 2 110B and the NAS2 110C is larger than the predetermined threshold. Specifically, for example, loads on the NAS2 110B and the NAS3 110C are “10” and “90”, respectively. When a difference of loads “80” is larger than the predetermined threshold, the migration using the shared volume cfs2 305 is executed.

In an example of FIG. 6, first, the fs2 302A is mounted on the NAS2 110B (1).

Subsequently, the shared volume cfs2 connected to the NAS3 110C is disconnected from the NAS3 110C and connected to the NAS2 110B (2). This disconnection and connection may be physically executed or may be executed according to logical path switching.

Subsequently, the storage position information 174 stored in the GNS management server 170 is updated (3). In the example of FIG. 6, “/gns/d2=NAS3:/mnt/fs2/file2” as shown in FIG. 3 is updated to “/gns/d2=NAS2:/mnt/fs2/file2”.

The fs2 302B is then unmounted (4).

After Step (3) ends, when the NAS client 160 attempts to access the file2 in the fs2 (write the file2 in or read the file2 from the fs2), the NAS client 160 refers to the storage position information 174 stored in the GNS management server 170. “/gns/d2=NAS2:/mnt/fs2/file2” indicates that the fs2 including the file2 is managed by the NAS2 110B. Therefore, the NAS client 160 issues an access request for the file2 to the NAS2 110B in accordance with the storage position information 174.

At a point when Step (2) in FIG. 6 ends, the fs2 302A includes the file2 updated on April 5 (i.e., old file2). On the other hand, the cfs2 305 includes the file2 updated on April 8 (i.e., new file2). After that, by writing the new file2 in the fs2 302A, the fs2 302A is updated to a latest state (5). This writing may be executed when a load on the NAS2 110B is lower than the predetermined threshold. When the writing in Step (5) ends, a time stamp of the file2 in the fs2 302A is updated to a new value (4/8) and the file2 in the cfs2 305 is deleted.

Before the update of the file systems in Step (5) ends, the NAS client 160 may issue an access request for the file2 to the NAS2 110B. In this case, the NAS2 110B executes the update in Step (5) for the file, which is the object of the access request, and executes the access requested. For example, when a file, which is the object of the read request, is included in the cfs2 305, the NAS2 110B reads the file from the cfs2 305, writes the file in the fs2 302A, and sends the file back to an issue source of the read request. This processing will be explained in detail later as shown in FIG. 11.

As shown in FIG. 6, when the migration using a shared volume is executed, after the connection of the shared volume is switched (2) and the storage position information 174 is updated (3), the NAS2 110B at the migration destination can receive an access request from the NAS client 160 even before the content of the shared volume cfs2 305 is copied to the fs2 302A at the migration destination. As a result, a load on the NAS3 110C is distributed to the NAS2 110B without waiting for the end of copy of data. Therefore, even when the reversal of loads among the respective NASs 110 frequently occurs due to intense fluctuation in loads, it is possible to distribute the loads on the NASs 110 at high speed and balance the loads following the fluctuation in loads.

Although only one shared volume 305 is shown in FIGS. 3 to 6, one shared volume may be prepared for each of the file systems. In that case, as explained with reference to FIGS. 3 to 6, the migration by switching the respective shared volumes is executed.

When the free capacity of the external storage system 140 is completely used as a result of an increase in an amount of data stored in the shared volume 305, the content of the shared volume may be copied to another external storage system having enough room of capacity. When the copy ends, the content of the shared volume 305 at the copy source is deleted.

The processing shown in FIGS. 3 to 6 will be hereinafter explained more in detail with reference to a flowchart.

As explained with reference to FIGS. 1 and 2, the respective processing modules of the NASs 110 are programs stored in the memory 204 and executed by the CPU 202. Therefore, respective kinds of processing executed by the respective processing modules of the NAS 110 in the following explanation are actually executed by the CPU 202. Similarly, respective kinds of processing executed by the respective processing modules in the disk controller 121, the disk controller 141, and the NAS client 160 are executed by the CPU 123, the CPU 143, and the CPU 161, respectively.

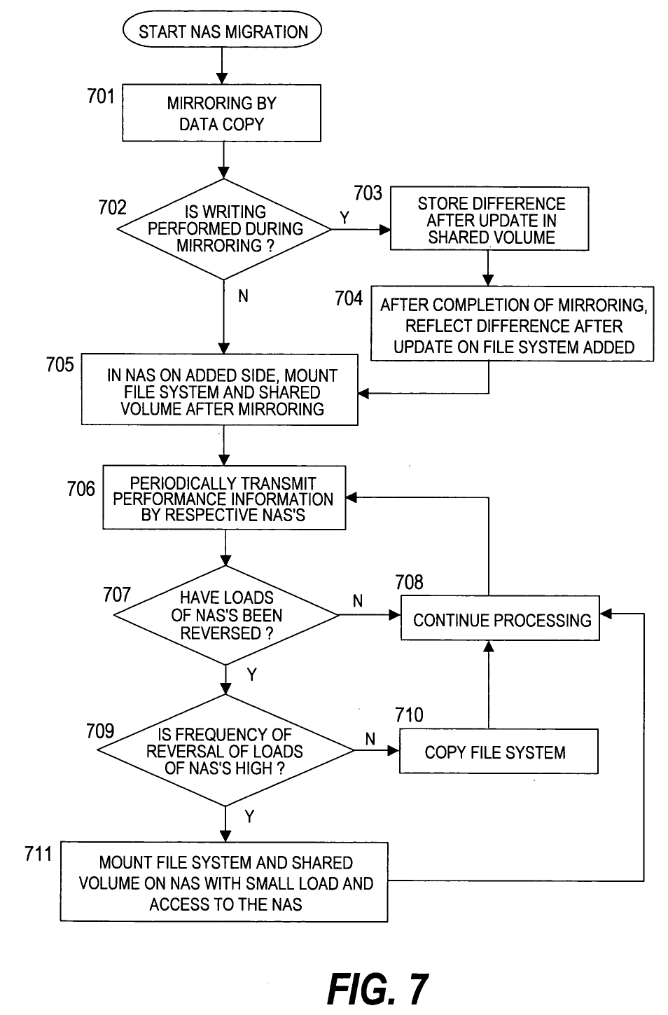

FIG. 7 is a flowchart showing entire load distribution processing executed in the computer system according to the embodiment of this invention.

When load distribution processing by the migration of the NAS 110 starts, the remote copy processing module 126 of the storage system 100 executes mirroring of file systems by data copy (701). Processing in Step 701 corresponds to Step (1) in FIG. 3.

The file system processing module 230 of the NAS 110 judges whether a write request for a file belonging to a file system to be subjected to mirroring is received from the NAS client 160 during execution of the mirroring in Step 701 (i.e., before copy of all data ends) (702).

When it is judged in Step 702 that a write request is not received during the execution of the mirroring, the processing proceeds to Step 705.

On the other hand, when it is judged in Step 702 that a write request is received during the execution of the mirroring, the file system processing module 230 of the NAS 110 stores a difference between a file updated by the write request and the file before update in the shared volume 305 (703). After the mirroring ends, the file system processing module 230 of the NAS 110 reflects the difference stored in the shared volume 305 on the file system to be subjected to mirroring (in the example of FIG. 3, the fs2 302B) (704).

Subsequently, the file system processing module 230 of the NAS 110 at a migration destination mounts the file system subjected to mirroring and the shared volume 305 (705). Processing in Step 705 corresponds to Steps (3) and (4) in FIG. 3.

After that, an operation of the file system mounted in Step 705 is started. During the operation, each of the NASs 110 periodically measures a load on the NAS and transmits a value measured to the GNS management server 170 (706). The GNS management server 170 stores the value transmitted in the memory 173 as the load information 175.

The load distribution processing module 210 of each of the NASs 110 judges whether loads on the NASs 110 at the migration source and the migration destination have been reversed (707). In the example of FIG. 4, it is judged whether a load on the NAS3 110C at the migration destination has become higher than a load on the NAS2 110B at the migration source.

When it is judged in Step 707 that the loads on the NASs 110 have not been reversed (e.g., when the loads are the values shown in FIG. 4), the operation of the file system mounted in Step 705 is continued (708).

On the other hand, when it is judged in Step 707 that the loads on the NASs 110 have been reversed (e.g., when the loads are the values shown in FIGS. 5 and 6), in Step 709 and the subsequent steps, the migration is executed. The migrations in Step 709 and the subsequent steps are a migration in an opposite direction in which the migration source and the migration destination in the migration executed in Steps 701 to 705 are set as a migration destination and a migration source, respectively.

First, the load distribution processing module 210 judges whether frequency of the reversal of loads is high (709). The judgment in Step 709 is executed by, for example, as explained with reference to FIGS. 5 and 6, judging whether a difference of loads on the NASs 110 exceeds the threshold.

When it is judged in Step 709 that the frequency of the reversal of loads is low, the load distribution processing module 210 executes the migration by data copy explained with reference to FIG. 5 (710). After that, an operation of the file system at the data copy destination is continued (708). After that, the processing in Step 706 is periodically executed.

On the other hand, when it is judged in Step 709 that the frequency of the reversal of loads is high, the load distribution processing module 210 executes the migration using the shared volume 305 explained with reference to FIG. 6 (711). Specifically, a file system is mounted on the NAS 110 with a small load (Step (1) in FIG. 6) and the shared volume 305 is mounted on the same NAS 110 (Step (2) in FIG. 6). After that, the NAS client 160 issues an access request to the NAS 110 on which the file system is mounted in Step 711. After that, an operation of the file system mounted on the NAS 110 with a small load is continued (708). After that, the processing in Step 706 is periodically executed.

After the shared volume 305 is mounted on the NAS 110 with a small load in Step 711, the file stored in the shared volume 305 is copied to a file system managed by the NAS 110 on which the shared volume 305 is mounted as shown in Step (5) in FIG. 6.

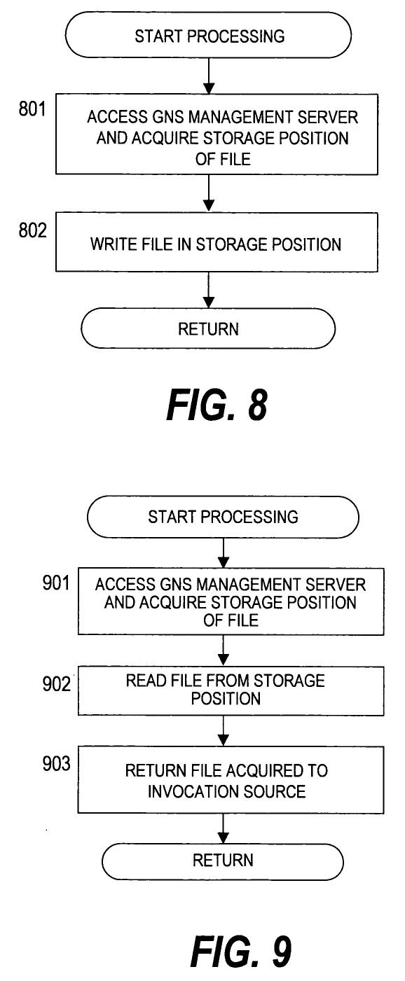

FIG. 8 is a flowchart showing processing executed by the write request processing module 164 of the NAS client 160 according to the embodiment of this invention.

The write request processing module 164 is a part of an OS (not shown) of the NAS client 160. When the write request processing module 164 is invoked by an application program (not shown), the processing in FIG. 8 is started.

First, the write request processing module 164 accesses the GNS management server 170 and acquires a storage position of a file, which is the object of a write request to be executed, from the storage position information 174 (801).

The write request processing module 164 issues the write request for the file to the storage position acquired in Step 801 (802).

Processing in Step 801 and 802 corresponds to the processing in Step (1) in FIG. 4.

Finally, the processing is ended.

FIG. 9 is a flowchart showing processing executed by the read request processing module 165 of the NAS client 160 according to the embodiment of this invention.

The read request processing module 165 is a part of an OS of the NAS client 160. When the read request processing module 165 is invoked by an application program, the processing in FIG. 9 is started.

First, the read request processing module 165 accesses the GNS management server 170 and acquires a storage position of a file, which is the object of a read request to be executed, from the storage position information 174 (901).

The read request processing module 165 issues the read request for the file to the storage position acquired in Step 901 (902).

The read request processing module 165 returns a file acquired as a result of Step 902 to an invocation source.

Finally, the processing is ended.

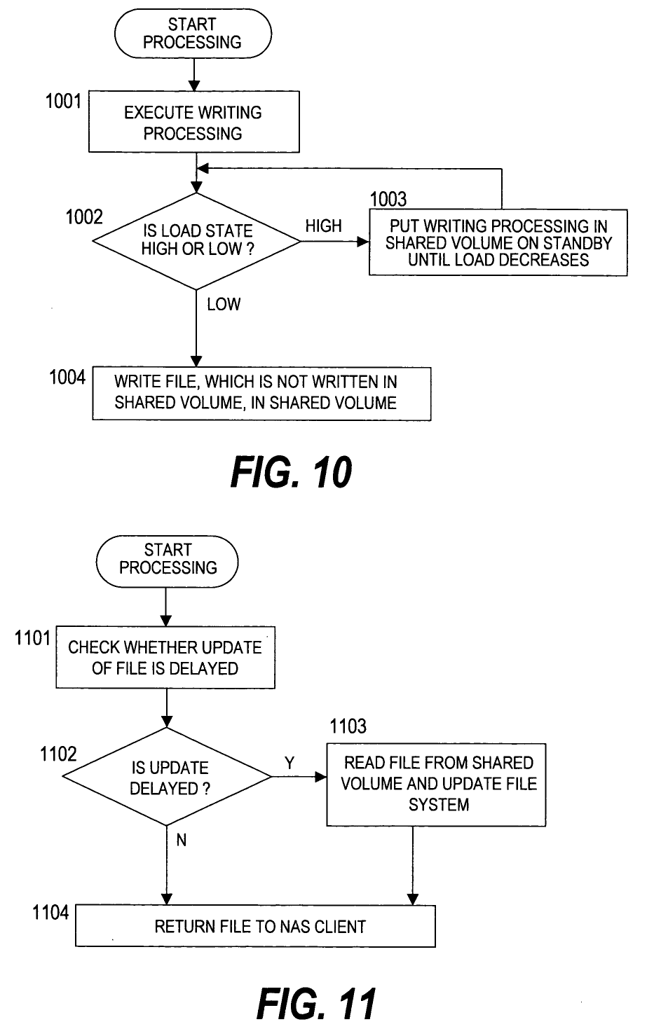

FIG. 10 is a flowchart showing writing processing executed by the file system processing module 230 according to the embodiment of this invention.

When the file sharing processing module 220 of the NAS 110 receives a write request from the NAS client 160, the file sharing processing module 220 issues a write request to the file system processing module 230. The file system processing module 230, which has received this write request, starts processing shown in FIG. 10.

First, the file system processing module 230 executes writing processing on a file system, which is the object of the write request (1001). Processing in Step 1001 corresponds to Step (1) in FIG. 4.

Subsequently, the file system processing module 230 judges whether a load on the NAS 110 including the file system processing module 230 is higher than the predetermined threshold (1002).

When it is judged in Step 1002 that the load on the NAS 110 is higher than the predetermined threshold, the file system processing module 230 puts processing for writing the file in the shared volume 305 on standby until the load decreases to be equal to or lower than the predetermined threshold (1003). After that, the processing returns to Step 1002.

When it is judged in Step 1002 that the load on the NAS 110 is equal to or lower than the predetermined threshold, the file system processing module 230 writes the file, which is written in the file system but is not written in the shared volume 305 yet, in the shared volume 305 (1004). Processing from Steps 1002 to 1004 corresponds to Step (2) in FIG. 4.

By executing Step 1004 when the load on the NAS 110 is low, it is possible to execute writing in the shared volume 305 without impeding other processing by the NAS 110.

FIG. 11 is a flowchart showing readout processing executed by the file system processing module 230 according to the embodiment of this invention.

When the file sharing processing module 220 of the NAS 110 receives a read request from the NAS client 160, the file sharing processing module 220 issues a read request to the file system processing module 230. The file system processing module 230, which has received the read request, starts the processing shown in FIG. 11.

For example, the file system processing module 230 of the NAS2 110B, which has received the read request from the NAS client 160 after Step (4) has ended in the example in FIG. 6, executes the processing shown in FIG. 11. The processing will be hereinafter explained on the basis of the example of FIG. 6.

First, the file system processing module 230 checks whether update of a file, which is the object of the read request, is delayed (1101). Specifically, when the writing in Step (5) in FIG. 6 has not been finished for the file to be read, it is judged in Step 1101 that update of the file is delayed.

When it is judged in Step 1101 that update of the file to be read is delayed, a latest file, which is the object of the read request, is included in the cfs2 305 rather than in the fs2 302A. In this case, the file system processing module 230 reads the latest file to be read from the cfs2 305 and writes the file read in the fs2 302A (1103).

Subsequently, the file system processing module 230 returns the file read from the cfs2 305 in Step 1103 to the NAS client 160 (1104).

On the other hand, when it is judged in Step 1101 that the update of the file, which is the object of the read request, is not delayed, the latest file, which is the object of the read request, is included in the fs2 302A. In this case, the file system processing module 230 reads the file from the fs2 302A and returns the file to the NAS client 160 (1104).

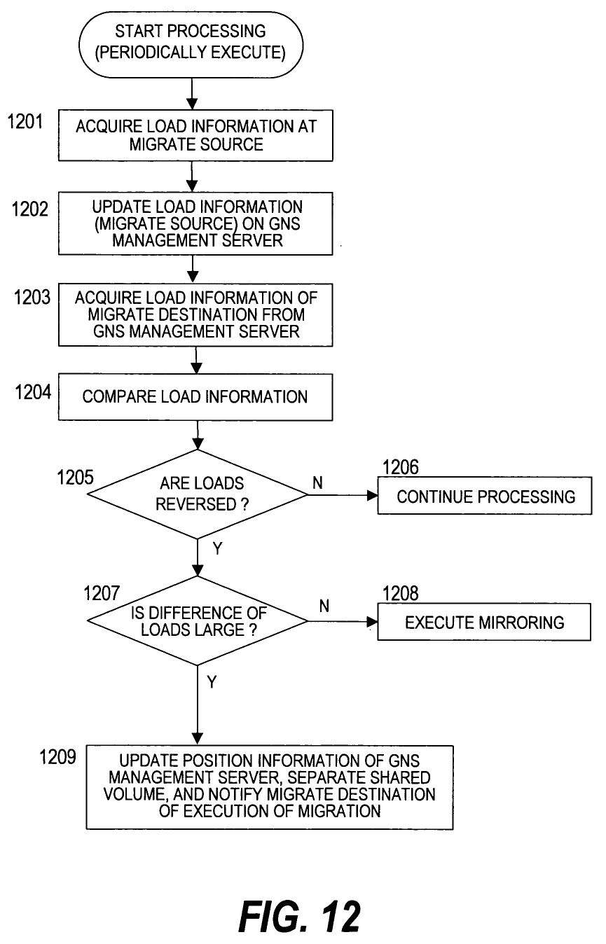

FIG. 12 is a flowchart showing load monitoring processing executed by the load distribution processing module 210 according to the embodiment of this invention.

In an explanation of FIG. 12, a “migration source” corresponds to the NAS3 110C in FIG. 4 and a “migration destination” corresponds to the NAS2 110B in FIG. 4.

Specifically, FIG. 12 is a flowchart for explaining in detail the load monitoring processing executed by the load distribution processing module 210 at the migration source in Step 706 and the subsequent steps in FIG. 7. The processing in FIG. 12 is periodically executed.

First, the load distribution processing module 210 acquires load information of the migration source (1201).

Subsequently, the load distribution processing module 210 updates load information of the migration source in the load information 175 of the GNS management server 170 to load information acquired in Step 1201 (1202).

The load distribution processing module 210 acquires load information of the migration destination from the GNS management server 170 (1203).

The load distribution processing module 210 compares the load information of the migration source acquired in Step 1201 and the load information of the migration destination acquired in Step 1203 (1204).

The load distribution processing module 210 judges whether the loads are reversed as a result of the judgment in Step 1204 (1205). This judgment corresponds to Step 707 in FIG. 7. Specifically, when the load on the migration source (in the example of FIG. 4, the NAS3 110C) is larger than the load on the migration destination (in the example of FIG. 4, the NAS2 110B), it is judged that the loads are reversed.

When it is judged in Step 1205 that the loads are not reversed, since it is unnecessary to execute migration, an operation of a file system managed by the migration source is continued (1206).

On the other hand, when it is judged in Step 1205 that the loads are reversed, the load distribution processing module 210 judges whether the reversal of loads frequently occurs (1207). This judgment corresponds to Step 709 in FIG. 7. Therefore, the judgment in Step 1207 is executed by judging whether a difference of the loads is larger than the predetermined threshold as in Step 709.

When it is judged in Step 1207 that the difference of the loads is equal to or smaller than the predetermined threshold, the load distribution processing module 210 executes data copy (i.e., mirroring) from the migration source to the migration destination (1208). This processing corresponds to Step 710 in FIG. 7.

On the other hand, when it is judged in Step 1207 that the difference of the loads is larger than the threshold, the load distribution processing module 210 updates the storage position information 174 of the GNS management server 170, separates the shared volume 305, and notifies the migration destination that the migration using a shared volume 305 will be executed (1209). This processing corresponds to Step 711 in FIG. 7.

When writing in the shared volume 305 is delayed, the load distribution processing module 210 executes Step 1209 after reflecting the delayed writing on the shared volume 305.

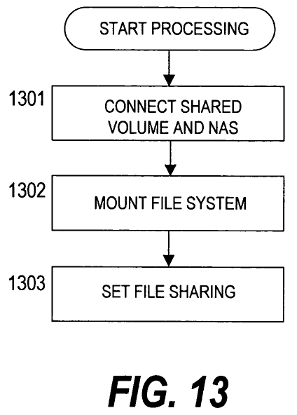

FIG. 13 is a flowchart showing takeover processing executed by the load distribution processing module 210 according to the embodiment of this invention.

A “migration source” and a “migration destination” in an explanation of FIG. 13 are used in the same meaning as those in FIG. 12.

Specifically, FIG. 13 shows processing executed by the load distribution processing module 210 of the migration destination that has received the notice in Step 1209 in FIG. 12.

When the load distribution processing module 210 receives the notice in Step 1209, the load distribution processing module 210 connects the shared volume 305 and the NAS 110 at the migration destination (1301). This processing corresponds to Step (2) in FIG. 6.

After the shared volume 305 is connected to the NAS 110 at the migration destination in Step 1301, the file stored in the shared volume 305 is copied to a file system managed by the NAS 110 at the migration destination as shown in Step (5) in FIG. 6.

The load distribution processing module 210 mounts the file system on the NAS 110 at the migration destination (1302). This processing corresponds to Step (1) in FIG. 6.

The load distribution processing module 210 performs setting for file sharing (1303). Specifically, the load distribution processing module 210 takes over a setting of file sharing from the NAS 110 at the migration source.

Finally, the processing of FIG. 13 is ended.

According to the embodiment of this invention, an updated file is stored in a shared volume connected to NAS server (i.e., NAS 110). It is possible to execute high-speed migration by connecting the shared volume to a NAS server at a migration destination. As a result, even when loads on the NAS servers suddenly fluctuate, it is possible to distribute the loads on the NAS servers at high speed by executing migration at high speed following the fluctuation.

What is claimed is:

1. A method for controlling a computer system including a first server computer, a second server computer, at least one data storing device, and a client computer,
the first server computer, the second server computer, and the client computer being coupled via a network,
the first server computer and the second server computer being coupled to the at least one data storing device,
the first server computer managing a first file system in any one of the data storing devices,
the second server computer managing a second file system in any one of the data storing devices,
the second file system including data copied from the first file system, and
data written in the second file system after data is copied from the first file system being stored in a shared volume in any one of the data storing devices,
the method comprising:
comparing a load on the second server computer and a load on the first server computer; and
when the load on the second server computer is higher than the load on the first server computer, starting copy of the data stored in the shared volume to the first file system and issuing an access request from the client computer to the first server computer.

2. The method according to claim 1, further comprising, when the access request issued to the first server computer is a read request for data and the data, which is an object of the read request, is not copied from the shared volume to the first file system yet, reading the data, which is the object of the read request, from the shared volume and returning the read data to the client computer.

3. The method according to claim 1, wherein the copy of the data stored in the shared volume to the first file system is executed when the load on the first server computer is lower than a predetermined threshold.

4. The method according to claim 1, further comprising,
when the load on the second server computer is not higher than the load on the first server computer, issuing the access request from the client computer to the second server computer, and
when the access request issued to the second server computer is a write request for data, writing the data, which is an object of the write request, in the second file system and the shared volume.

5. The method according to claim 4, wherein the writing of the data in the shared volume is executed when the load on the second server computer is lower than a predetermined threshold.

6. The method according to claim 1, wherein
when the load on the second server computer is higher than the load on the first server computer, judging whether frequency of reversal of the load on the first server computer and the load on the second server computer is higher than a predetermined threshold,
when it is judged that the frequency is not higher than the predetermined threshold, copying the data, which is written in the second file system after data is copied from the first file system, to the first file system,
issuing the access request from the client computer to the first server computer after the copy of the data to the first file system ends, and
when the access request issued to the first server computer is a read request for data, reading the data, which is an object of the read request, from the first file system and returning the data read to the client computer.

7. The method according to claim 6, further comprising, when a difference between the load on the first server computer and the load on the second server computer is larger than a predetermined threshold, judging that frequency of reversal of the load on the first server computer and the load on the second server computer is higher than a predetermined threshold.

8. A computer system, comprising:
a first server computer;
a second server computer;
at least one data storing device; and
a client computer, wherein:
the first server computer, the second server computer, and the client computer are coupled via a network;
the first server computer and the second server computer are coupled to the at least one data storing device;
the first server computer includes a first interface coupled to the network, a first processor coupled to the first interface, and a first memory coupled to the first processor;
the first server computer manages a first file system in any one of the data storing devices;
the second server computer includes a second interface coupled to the network, a second processor coupled to the second interface, and a second memory coupled to the second processor;
the second server computer manages a second file system in any one of the data storing devices;
the second file system includes data copied from the first file system;
the client computer includes a third interface coupled to the network, a third processor coupled to the third interface, and a third memory coupled to the third processor;
data written in the second file system after data is copied from the first file system is stored in a shared volume in any one of the data storing devices;
the first server computer starts, when the load on the second server computer is higher than the load on the first server computer, copy of the data stored in the shared volume to the first file system; and
the client computer issues, when the load on the second server computer is higher than the load on the first server computer, an access request to the first server computer.

9. The computer system according to claim 8, wherein, when the access request issued to the first server computer is a read request for data and the data, which is an object of the read request, is not copied from the shared volume to the first file system yet, the first server computer reads the data, which is the object of the read request, from the shared volume and returns the read data to the client computer.

10. The computer system according to claim 8, wherein:
the client computer issues, when the load on the second server computer is not higher than the load on the first server computer, an access request to the second server computer; and
when the access request issued from the client computer is a write request for data, the second server computer writes the data, which is an object of the write request, in the second file system and the shared volume.

11. The computer system according to claim 8, wherein:
when the load on the second server computer is higher than the load on the first server computer and frequency of reversal of the load on the first server computer and the load on the second server computer is equal to or lower than a predetermined threshold, the second server computer copies data, which is written in the second file system after data is copied from the first file system, to the first file system;
the client computer issues the access request to the first server computer after the copy of the data to the first file system ends; and
when the access request issued to the first server computer is a read request for data, the first server computer reads the data, which is an object of the read request, from the first file system and returns the read data to the client computer.

12. The computer system according to claim 11, wherein, when a difference between the load on the first server computer and the load on the second server computer is larger than a predetermined threshold, it is judged that the frequency of the reversal of the load on the first server computer and the load on the second server computer is higher than a predetermined threshold.

13. A server computer coupled to at least one data storing device and a client computer,
the server computer being coupled to the client computer via a network,
the server computer being coupled to the at least one data storing device,
the server computer including an interface coupled to the network, a processor coupled to the interface, and a memory coupled to the processor,
the server computer managing a file system in any one of the data storing devices, wherein:
data written in another file system after data is copied to the another file system from the file system is stored in a shared volume in any one of the data storing devices; and
the processor starts, when a load on another server computer that manages the another file system is higher than a load on the server computer, copy of the data stored in the shared volume to the file system.

14. The server computer according to claim 13, wherein the processor
receives an access request for data in the file system from the client computer,
reads, when the access request received is a read request for the data and the data, which is an object of the readout request, is not copied from the shared volume to the file system yet, the data, which is the object of the read request, from the shared volume, and
returns the data read to the client computer.

15. A server computer coupled to at least one data storing device and a client computer,
the server computer being coupled to the client computer via a network,
the server computer being coupled to the at least one data storing device,
the server computer including an interface coupled to the network, a processor coupled to the interface, and a memory coupled to the processor,
the server computer managing a file system in any one of the data storing devices, wherein:
data written in the file system after data is copied to the file system from another file system is stored in a shared volume in any one of the data storing devices; and
the processor
receives an access request for data in the file system from the client computer and
writes, when the access request received is a write request for the data, the data, which is an object of the write request, in the file system and the shared volume.

16. The server computer according to claim 15, wherein, when a load on the server computer is higher than a load on another server computer that manages the another file system and frequency of the reversal of the load on the server computer and the load on the another server computer is equal to or lower than a predetermined threshold, the processor copies data, which is written in the file system after data is copied from the another file system, to the another file system.

17. The server computer according to claim 16, wherein, when a difference between the load on the server computer and the load on the another server computer is larger than a predetermined threshold, the processor judges that the frequency of the reversal of the load on the server computer and the load on the another server computer is higher than a predetermined threshold.
